(19) United States
(12) Patent Application Publication
(10) Pub. No.: US 2004/0059606 A1
(43) Pub. Date: Mar. 25, 2004

(54) Method and apparatus for checking codings in the health service

(76) Inventors: Michael Mankopf, Mohrendorf (DE); Volker Schmidt, Erlangen (DE)

Correspondence Address: YOUNG & THOMPSON, 745 SOUTH 23RD STREET 2ND FLOOR, ARLINGTON, VA, 22202

(21) Appl. No.: 10/252,372

(22) Filed: Sep. 24, 2002

(51) Int. Cl. G06F 17/00

(52) U.S. Cl. 705/3; 706/924; 707/1; 128/920

(57) ABSTRACT

A method and apparatus for checking a patient's associated codings in the health service, the codings being associated with a medical profile of the patient.

### FIELD OF THE INVENTION

The invention relates to a method and an apparatus for checking a patient's associated codings in the health service.

### BACKGROUND OF THE INVENTION

It is normal practice in the health service to use specific internationally familiar coding systems to code medical facts, such as a diagnosis for a patient or medical procedures performed on the patient, such as operations or examinations. In Germany, for example, medical procedures are coded on the basis of the International Classification of Procedures in Medicine (ICPM) in line with § 301 SGB V [Code of Social Law].

Such codings are used, inter alia, as a basis for reimbursing the doctors and hospitals. Thus, by way of example, the “DRG coding system” (Diagnosis Related Groups) is used in the US state of New Jersey in order to reimburse medicare insurance policyholders treated in hospital.

In line with a press release dated Dec. 1, 2000 from the Deutsches Institut für medizinische Dokumentation und Information (DIMDI), the International Classification of Diseases-10 (ICD-10) and the operation key based on § 301 SGB V, version 2.0, are available. Both classifications were extensively revised for the introduction of an all-inclusive fee system on the basis of the Australian Refined Diagnosis Related Groups (AR-DRGs).

The above coding systems are complicated; this means that medical facts are inadvertently coded incorrectly from time to time. Since the codings are also the basis of payment, medical facts are also sometimes coded incorrectly with intent to deceive. DE 198 25 191 A1 discloses an apparatus for capturing, processing and logging patient-related data in advance and during medical treatment. The apparatus comprises a server with access to a database, storing patient-related data, and at least one client which is networked to the server. The client can access the patient-related data in the database, and the server can access data which can be retrieved from the client. The apparatus also comprises at least one mobile data capture system and means for data transfer between the mobile data capture system and the server or the client.

DE 40 23 785 A1 describes a system for storing, providing and updating fixed and/or variable patient and treatment data. The system comprises a fixed computer central unit and a mobile unit. The mobile unit is used for house visits and rounds using a medical insurance card.

### SUMMARY OF THE INVENTION

The object of the invention is therefore to specify a method and an apparatus which provide prerequisites for easy checking of codings in the health service.

The first object is achieved by a method for checking a patient's associated codings in the health service, having the following method steps:

a patient's associated codings in the health service are received using a central database, the codings being associated with a medical profile of the patient,

medical data suitable for describing the patient's treatment are received using the database, and

a check is carried out to determine whether the codings can be associated with the actual treatment of the patient.

According to the invention, the codings which are associated with the patient and describe his medical profile are thus transmitted to the central database. By way of example, as provided on the basis of one variant of the invention, these codings can be based on the International Classification of Diseases (ICD), the International Classification of Procedures in Medicine (ICPM) and/or the Diagnosis Related Groups (DRG) coding system. If the medical profile comprises a type for the patient's illness, it would thus be possible to use the ICD or DRG coding system, for example. A medical procedure performed on the patient could be coded on the basis of the ICPM coding system. In this connection, procedures are understood to mean, by way of example, examinations, particularly using medical instruments, or operations on the patient.

In addition, on the basis of the invention, the patient's treatment is described by transferring suitable medical data to the database. These data can likewise be coded and can, inter alia, on the basis of one variant of the invention, comprise a detail relating to medicaments prescribed, examinations performed and/or laboratory tests performed for the patient.

The invention involves checking whether the patient's treatment is concurrent with the codings on the basis of the medical data. A check on the coding on the basis of a medicament is, by way of example, a check to determine whether a patient for whom a doctor providing treatment made a hypertension diagnosis and coded it accordingly actually received an antihypertensive medicament. Another example is a hepatitis diagnosis for a patient which was also coded accordingly. For diagnosed hepatitis, hepatitis serology, that is to say a suitable laboratory test, would need to have been performed. For correct coding of the hepatitis diagnosis, medical data which can be associated with hepatitis serology thus also need to be available. In addition, the hepatitis serology performed would need to point to hepatitis.

On the basis of the patient's treatment, it is thus possible to inder the patient's associated codings and hence to check the codings.

In accordance with one variant of the invention, the medical data are associated with at least one written document, which is a medical note, in particular. If the patient is treated in a hospital, for example, the patient's family doctor, that is to say the doctor whom the patient regularly visits, normally receives a medical note when the patient is discharged from the hospital. The medical note generally comprises a detail relating to the patient's diagnosis, treatment which has been performed, medicaments prescribed and/or a recommendation for further treatment of the patient following his stay in hospital. These details can again allow the patient's associated codings to be inferred; these details thus also permit the patient's associated codings to be checked.

In accordance with one particularly preferred variant of the invention, the data associated with the written document can be evaluated using means for text analysis on the basis of specific headwords, the headwords allowing the patient's treatment to be inferred, for example. The headwords are, by way of example, diseases, medicaments, diagnoses or medical procedures performed on the patient. It is thus a simple matter to evaluate the written document and hence to check the codings automatically.

To ensure that the medical data are transferred with as broad a scope of application as possible, one particularly preferred variant of the invention involves their being transmitted using the Health Level 7 (HL7), the results data medium (BDT), the VCS format, the Digital Imaging and Communications in Medicine (DICOM) standard and/or the laboratory data medium (LDT) format. These formats are specific coding methods used in particular in hospitals for transmitting laboratory data.

In accordance with another embodiment of the invention, the medical data have at least one associated medical image of the patient which has been produced using an imaging medical instrument. On the basis of one embodiment of the invention, the medical instrument is an X-ray instrument, a computer tomograph, a magnetic resonance instrument and/or an ultrasound instrument. In accordance with one embodiment of the invention, the medical image can be evaluated using image-processing means, and the evaluation of the medical image can be used for checking whether the actual treatment of the patient can be associated with the codings. If the medical image is, by way of example, an X-ray image of a patient who has sustained a bone fracture, then the image-processing means can be in a form such that they automatically identify the bone fracture on the basis of the image data associated with the X-ray image. If the X-ray image now shows a bone fracture, a coding associated with the patient which corresponds to the bone fracture diagnosis for the patient appears plausible.

In accordance with one particularly preferred embodiment of the invention, an evaluation device which is associated with the database and comprises a knowledge-based system is used to check whether the actual treatment of the patient can be associated with the codings. In this case, on the basis of one variant of the invention, the knowledge-based system comprises a neural network, a causal probabilistic network, a fuzzy system, a rule-based system and/or a decision tree.

The inventive method is particularly useful if, in accordance with one variant of the invention, the database is operated by a hospital, a health insurance institution, a health insurance company and/or a medical payment center. If the database is operated by the hospital, it can be connected to a hospital information system, which makes it a simple matter to transmit the codings associated with the patient and the medical data suitable for describing the actual treatment of the patient to the database.

The second object of the invention is achieved by an apparatus for checking a patient's associated codings in the health service, having

a central database to which data associated with the codings and medical data suitable for describing the patient's treatment can be transmitted, the codings being associated with a medical profile of the patient, and

an evaluation device having a knowledge-based system which checks the plausibility of the data associated with the coding and of the data associated with the patient's treatment.

The inventive apparatus can thus be used for carrying out the inventive method.

Advantageous refinements of the inventive apparatus can be found in the subclaims.

### BRIEF DESCRIPTION OF THE DRAWINGS

Exemplary embodiments are illustrated by way of example in the appended schematic drawings, in which:

FIG. 1 shows a cardiologist's medical practice,

FIG. 2 shows a flowchart illustrating the inventive method, and

FIG. 3 shows a hospital.

### DETAILED DESCRIPTION OF THE INVENTION

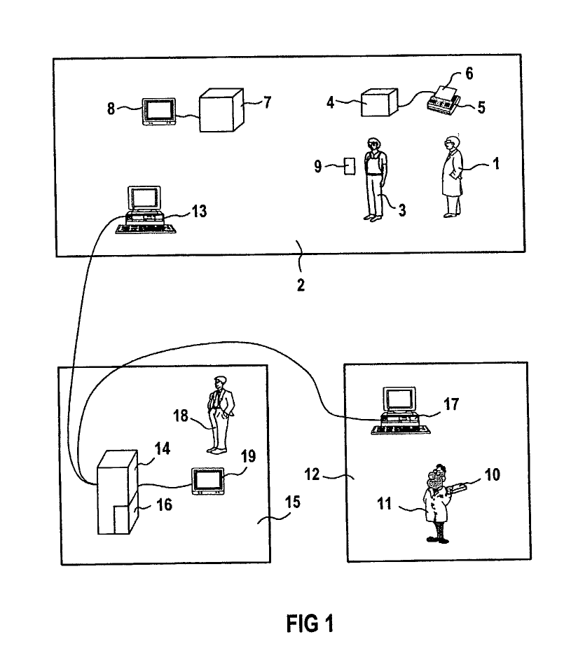

FIG. 1 shows a cardiologist 1 examining a patient 3 in his medical practice 2. In the case of the present exemplary embodiment, the patient 3 is complaining of cardiac trouble, which is why the cardiologist 1 uses an ECG instrument 4 in the medical practice 2 to produce an ECG for the patient 3. While the ECG is being produced, a printer 5 connected to the ECG instrument 4 produces a printout 6 of the ECG. In addition, the cardiologist 1 examines the heart of the patient 3 using an ultrasound instrument 7 in the medical practice 2. The images of the heart of the patient 3 produced while the patient 3 is being examined using the ultrasound instrument 7 can be viewed by the cardiologist 1 on a monitor 8 connected to the ultrasound instrument 7.

On the basis of the printout 6 of the ECG and the examination using the ultrasound instrument 7, the cardiologist 1 diagnoses a cardiac insufficiency in the patient 3. In the case of the present exemplary embodiment, the cardiac insufficiency is relatively slight, so that the cardiologist 1 prescribes a diuretic 10 for the patient 3 as a medicament and gives him a corresponding prescription 9.

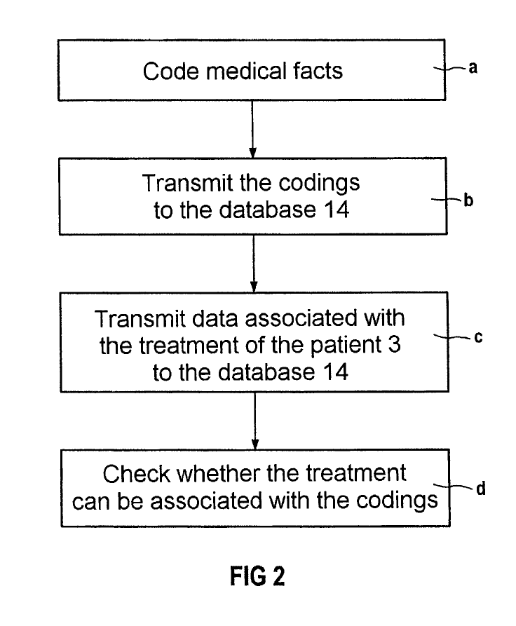

When the patient 3 has left the medical practice 2 of the cardiologist 1, the cardiologist 1 codes the cardiac insufficiency of the patient 3 on the basis of the ICD (International Classification of Diseases) coding system customary in Germany. The corresponding ICD coding is I11.0. In addition, the cardiologist 1 codes the examinations performed on the patient 3, that is to say the ECG produced and the examination using the ultrasound instrument 7 in line with the ICPM (International Classification of Procedures in Medicine) coding system customary in Germany. The codings for the ECG produced and for the examination using the ultrasound instrument 7 are 1-724 and 5-952.0, respectively (step a in the flowchart shown in FIG. 2).

The cardiologist 1 then stores the ascertained codings in a computer 13 in the medical practice 2, which stores an electronic patient file for the patient 3. The cardiologist 1 then transmits the codings with the identity of the patient 3 to a database 14 which is in an office 15 at the health insurance institution associated with the patient 3 and receives the transmitted codings. The codings are, besides, a basis for the health insurance institution associated with the patient 3 to pay the cardiologist 1. In the case of the present exemplary embodiment, the codings are transmitted over the Internet, to which the computer 13 and the database 14 are connected (step b in the flowchart shown in FIG. 2).

When the patient 3 has left the medical practice 2 of the cardiologist 1, he goes to a pharmacy 12 belonging to a pharmacist 11, who gives the patient 3 the diuretic 10 prescribed by the cardiologist 1 on the basis of the prescription 9 which the patient 3 hands to him. The patient 3 can thus start to treat his cardiac insufficiency by taking the diuretic 10 prescribed by the cardiologist 1 in line with an instruction given by the cardiologist 1.

The pharmacist 11 then enters the dispensing of the diuretic 10 to the patient 3 in a computer 17 which is in the pharmacy 12 and is connected to the Internet. The information regarding the dispensing of the diuretic 10 to the patient 3 is likewise transmitted to the database 14 at the health insurance institution associated with the patient 3, so that the pharmacist 11 can be reimbursed as appropriate by the health insurance institution associated with the patient 3 for dispensing the diuretic 10 (step c in the flowchart shown in FIG. 2).

In the case of the present exemplary embodiment, the database 14 thus receives codings associated with the patient 3 and data associated with the treatment of the patient 3. The codings are associated with the diagnosis of the patient 3 and with the medical procedures performed on the patient 3, that is to say with a medical profile of the patient 3. The treatment of the patient 3 consists in the taking of the diuretic 10 prescribed by the cardiologist 1.

In the case of the present exemplary embodiment, an evaluation device 16 associated with the database 14 uses a suitable computer program to check the codings transmitted to the database 14 by the cardiologist 1 by comparing coding associations stored in the database 14 together with treatments to be expected with the codings transmitted by the cardiologist 1 and with the treatment of the patient 3 (step d in the flowchart shown in FIG. 2).

In the case of the present exemplary embodiment, the cardiologist 1 diagnosed a cardiac insufficiency in the patient 3. For a cardiac insufficiency, in the case of the present exemplary embodiment, the computer program contains a stipulation that, to make this diagnosis, a doctor at least produces an ECG, but can also perform an ultrasound examination. Treatment to be expected for a cardiac insufficiency is the taking of a diuretic or the employment of a cardiac pacemaker, depending on the cause of the cardiac insufficiency.

In the case of the present exemplary embodiment, the computer program checks, on the basis of the DRG coding “I11.0” (“cardiac insufficiency”), whether an ECG has been produced and possibly an ultrasound examination has been performed on the patient 3. The computer program then checks whether the treatment performed on the patient 3 can be associated with the “cardiac insufficiency” diagnosis.

In the case of the present exemplary embodiment, the cardiologist 1 not only produced an ECG but also performed an ultrasound examination. On account of the corresponding codings which the cardiologist 1 transmitted to the database 14, this is known to the computer program stored in the evaluation device 16. Furthermore, the cardiologist 1 prescribed the diuretic 10 for the patient 3, and this was dispensed to the patient 3 by the pharmacist 11. This is likewise known to the computer program, which means that it identifies from the data transferred to the database 14 that the codings from the cardiologist 1 are plausible.

Should the computer program ascertain an implausible coding, for example because the cardiologist 1 made a mistake when entering the codings and coded a treatment using a lithotripter instead of an ultrasound examination, for example, this is identified by the computer program. A monitor 19 connected to the database 14 then displays advice that the cardiologist 1 has transmitted an implausible coding to the database 14. This advice is intended for an employee 18 of the health insurance institution associated with the patient 3, and the employee can then check the implausible coding and can contact the cardiologist 1 if appropriate.

Should, furthermore, the printout 6 of the ECG performed on the patient 3 by the cardiologist 1 be available in digital form, the data associated with the printout 6 could likewise be transmitted to the database 14. The computer program stored in the evaluation device 16 can then use a pattern recognition algorithm to analyze these data for advice of a cardiac insufficiency. Should there be advice of a cardiac insufficiency, the coded “cardiac insufficiency” diagnosis is plausible, otherwise it is implausible.

A document produced by the cardiologist 1, for example a medical note, could also be transmitted to the database 14 in digitized form. A suitable text analysis algorithm and the computer program stored in the evaluation device 16 could then be used to search this document for particular headwords, for example, which permit the diagnosis made and hence the codings to be inferred.

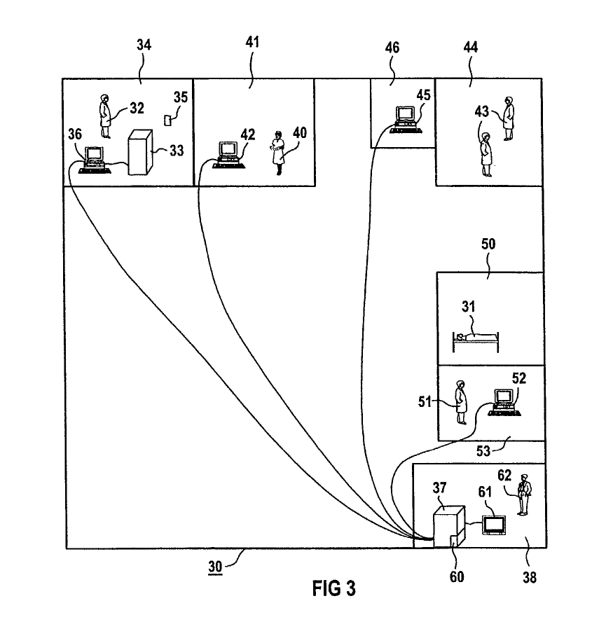

Another exemplary embodiment to illustrate the inventive method and the inventive system is shown schematically in FIG. 3.

FIG. 3 shows a hospital 30 to which a rescue team (not shown in FIG. 3) has delivered a patient 31. In the case of the present exemplary embodiment, the patient 31 had a road accident and is complaining of pain in the thigh.

Following arrival at the hospital 30, blood is taken from the patient 31 and is examined by a laboratory assistant 40 in a laboratory 41 at the hospital 30. The laboratory assistant 40 also ascertains an ICPM coding associated with the laboratory examination, enters it into a computer 42 and transmits it to a database 37. The computer 42 is in the laboratory 41, and the database 37 is in an administration room 38 at the hospital 30. The computer 42 is also connected to the database 37.

A radiologist 32 then uses an X-ray instrument 33 in a radiological department 34 at the hospital 30 to produce an X-ray image 35 of the painful thigh of the patient 31. On the basis of the X-ray image 35, the radiologist 32 diagnoses a complicated femoral fracture in the patient 31. The radiologist 32 then ascertains an associated ICPM coding for the X-ray examination and an ICD coding associated with the “femoral fracture” diagnosis, and enters the two codings into a computer 36 which is likewise in the radiological department 34. He then transmits the two codings to the database 37 to which the computer 36 is connected. In the case of the present exemplary embodiment, the X-ray instrument 33 is also connected to the computer 36, so that an image data record associated with the X-ray image 35 is likewise transmitted to the database 37 using the computer 36.

On the basis of the X-ray image 35, the patient 31 is then operated upon by an operating team 43 in an operating theater 44 at the hospital 30. Following the operation, one of the doctors in the operating team 43 enters an ICPM coding associated with the operation into a computer 45 which is in a side room 46 off the operating theater 44. The computer 45 is likewise connected to the database 37, so that the ICPM coding associated with the operation is likewise transmitted to the database 37.

Following the operation, the patient 31 is placed on a ward 50 at the hospital 30, where he receives ten days of in-hospital treatment in the case of the present exemplary embodiment. A ward doctor 51 enters the ICPM coding associated with this treatment into a computer 52 which is in a room 53 in the ward 50 and is likewise connected to the database 37, so that the ICPM coding entered by the ward doctor 51 is likewise transferred to the database 37.

In the case of the present exemplary embodiment, the database 37 comprises an evaluation device 60 storing a computer program which checks the plausibility of the codings which are associated with the patient 31 and have been transmitted to the database 37. This involves the computer program checking whether the treatment performed on the patient 31, that is to say the operation and the stay in hospital, the medical procedures performed, that is to say the laboratory examination, the X-ray of the thigh and the operation, are plausible on the basis of the “femoral fracture” diagnosis made, by virtue of said computer program first interpreting the codings associated with the patient 31 and comparing them with treatment and diagnosis associations stored in the database 37. In the case of the present exemplary embodiment, the database 37 stores that an X-ray image of the thigh can be expected for a “femoral fracture” diagnosis. If a complicated femoral fracture is involved, an operation with a subsequent stay in hospital can also be associated with the “femoral fracture” diagnosis. A complicated femoral fracture can be derived from the X-ray image 35 of the thigh. The evaluation device 60 therefore comprises a suitable pattern recognition program which can be used to analyze an image data record associated with an X-ray image in order to indicate a bone fracture. In addition, the pattern recognition program, which comprises a suitably trained neural network in the case of the present exemplary embodiment, is designed such that it can also distinguish between a complicated bone fracture and a less complicated bone fracture.

In the case of the present exemplary embodiment, the pattern recognition program analyzes the image data record which has been transmitted to the database 37 and is associated with the X-ray image 35, and ascertains that a complicated bone fracture is involved. The computer program stored in the evaluation device 60 therefore identifies that the “femoral fracture” diagnosis is correct and hence the ICD coding associated with the femoral fracture is correct. In addition, the operation and the stay in hospital by the patient 31 were plausible on the basis of the X-ray image 35, which means that the ICPM codings associated with the operation and with the stay in hospital are also plausible. Besides this, a laboratory examination is performed routinely for every patient, which means that the corresponding ICPM coding for the patient 31 is likewise identified as being plausible.

Should the computer program ascertain an implausible coding, for example because a medical fact has been coded incorrectly, this is displayed on a display unit 61 connected to the database 37, so that an employee 62 at the hospital 30 is informed about the implausible coding and can check the codings as appropriate.

As an aside, the pattern recognition program does not necessarily have to comprise a neural network. It can also comprise a causal probabilistic network, a fuzzy system, a rule-based system and/or a decision tree, in particular.

Other or further coding systems can also be used, such as the DRG coding system, in particular.

1. A method for checking a patient's associated codings in the health service, which comprises the following method steps:
receiving a patient's associated codings in the health service using a central database, the codings being associated with a medical profile of the patient,
receiving medical data suitable for describing the patient's treatment using the database, and
carrying out a check to determine whether the codings can be associated with the actual treatment of the patient.

2. The method as claimed in claim 1, in which the codings are based on the International Classification of Diseases (ICD), the International Classification of Procedures in Medicine (ICPM) and/or the Diagnosis Related Groups (DRG) coding system.

3. The method as claimed in claim 1, in which the medical data comprise a detail relating to medicaments prescribed, examinations performed and/or laboratory tests performed for the patient.

4. The method as claimed in claim 1, in which the medical data are associated with at least one written document, which is a medical note, in particular.

5. The method as claimed in claim 4, in which the data associated with the written document are evaluated using means for text analysis on the basis of specific headwords, the headwords allowing the actual treatment of the patient to be inferred.

6. The method as claimed in claim 1, in which the medical data are transmitted using the Health Level 7 (HL7), the results data medium (BDT), the VCS format, the Digital Imaging and Communications in Medicine (DICOM) standard and/or the laboratory data medium (LDT) format.

7. The method as claimed in claim 1, in which the medical data are associated with at least one medical image of the patient which has been produced using an imaging medical instrument.

8. The method as claimed in claim 7, in which the imaging medical instrument is an X-ray instrument, a computer tomograph, a magnetic resonance instrument and/or an ultrasound instrument.

9. The method as claimed in claim 7, in which the medical image is evaluated using image-processing means, and the evaluation of the medical image is used for checking whether the actual treatment of the patient can be associated with the codings.

10. The method as claimed in claim 1, in which an evaluation device which is associated with the database and comprises a knowledge-based system is used to check whether the patient's treatment can be associated with the codings.

11. The method as claimed in claim 10, in which the knowledge-based system comprises a neural network, a causal probabilistic network, a fuzzy system, a rule-based system and/or a decision tree.

12. The method as claimed in claim 1, in which the database is operated by a hospital, a health insurance institution, a health insurance company and/or a medical payment center.

13. An apparatus for checking a patient's associated codings in the health service, comprising
a central database to which data associated with the codings and medical data suitable for describing the patient's treatment can be transmitted, the codings being associated with a medical profile of the patient, and
an evaluation device having a knowledge-based system which checks the plausibility of the data associated with the coding and of the data associated with the patient's treatment.

14. The apparatus as claimed in claim 13, in which the codings are based on the International Classification of Diseases (ICD), the International Classification of Procedures in Medicine (ICPM) and/or the Diagnosis Related Groups (DRG) coding system.

15. The apparatus as claimed in claim 13, in which the medical data comprise a detail relating to medicaments prescribed (10), examinations performed and/or laboratory tests performed for the patient.

16. The apparatus as claimed in claim 13, in which the medical data are associated with at least one written document, which is a medical note, in particular.

17. The apparatus as claimed in claim 16, in which the data associated with the written document can be evaluated using means for text analysis on the basis of specific headwords, the headwords allowing the actual treatment of the patient to be inferred.

18. The apparatus as claimed in claim 13, in which the medical data can be transmitted using the Health Level 7 (HL7), the results data medium (BDT), the VCS format, the Digital Imaging and Communications in Medicine (DICOM) standard and/or the laboratory data medium (LDT) format.

19. The apparatus as claimed in claim 13, in which the medical data are associated with at least one medical image of the patient which has been produced using an imaging medical instrument.

20. The apparatus as claimed in claim 19, in which the imaging medical instrument is an X-ray instrument, a computer tomograph, a magnetic resonance instrument and/or an ultrasound instrument.

21. The apparatus as claimed in claim 19, in which the medical image is evaluated using image-processing means which are associated with the evaluation device.

22. The apparatus as claimed in claim 21, in which the knowledge-based system comprises a neural network, a causal probabilistic network, a fuzzy system, a rule-based system and/or a decision tree.

23. The apparatus as claimed in claim 13, in which the database is operated by a hospital, a health insurance institution, a health insurance company and/or a medical payment center.
